(19) United States
(12) Patent Application Publication
(10) Pub. No.: US 2020/0154631 A1
(43) Pub. Date: May 21, 2020

(54) AIR DRILL AND METHOD OF USE FOR CRUSHING GRANULAR PRODUCT TO BE DELIVERED INTO THE GROUND

(71) Applicant: Trevor Andrew Klein, Regina (CA)

(72) Inventor: Trevor Andrew Klein, Regina (CA)

(21) Appl. No.: 16/685,477

(22) Filed: Nov. 15, 2019

Related U.S. Application Data
(60) Provisional application No. 62/767,559, filed on Nov. 15, 2018.

(51) Int. Cl. A01C 21/00; A01C 15/00; A01C 15/04; A01C 15/06; B02C 4/08

(52) U.S. Cl. CPC A01C 21/002; A01C 15/006; B02C 4/08; A01C 15/06; A01C 15/04

(57) ABSTRACT

An agricultural implement comprises a container mounted on a frame arranged for movement across an agricultural field, which container is suited for storing a granular product to be deposited across the field. The agricultural implement additionally including a metering system arranged for metering the granular product in movement from a product exit of the container to a product discharge, typically in operative communication with a pneumatic conveying system, for eventual delivery to the agricultural field. The agricultural implement features a crushing system arranged for reducing a size of the granular product that is disposed in series with the metering system so as to be located between the product exit and the product discharge, such that metered quantities of the crushed granular product can be deposited into the ground as the agricultural implement is displaced in the forward working direction across the field.

This application claims the benefit under 35 U.S.C. 119(e) of U.S. provisional application Ser. No. 62/767,559, filed Nov. 15, 2018.

### FIELD OF THE INVENTION

The present invention relates to agricultural implements for depositing granular product in the ground, for example air drill.

### BACKGROUND

It is known in the agricultural industry that fertilizers, for example, nitrogen, potash, sulphur, phosphate and potassium, can be deposited on an agricultural field in a solid granular form or in liquid form.

Solid granular fertilizers are conventionally applied in a granule size which is much larger than many seed types and requires the fertilizer granules to be spaced far apart as compared to the corresponding seed spacing so that some seed receives too much fertilizer and other seed receives too little.

Deposition of the liquid form of the fertilizers via liquid applicators is preferred to provide more uniform dispersion over seeds as compared to depositing the solid granular form of the fertilizers using corresponding applicators; however, many farmers are deterred by liquid applicators because these involve additional infrastructure such as storage bins, pumping equipment, liquid trailers, and a special liquid cart, manifold, and pumping equipment. Logistics and additional labour is also a concern. From an efficiency perspective, loading up an air cart during seeding is an additional obstacle to farmers applying product as recommended by industry experts.

### SUMMARY OF THE INVENTION

According to one aspect of the invention there is provided an agricultural implement comprising:

a frame configured for movement across ground in a forward working direction;

at least one opener supported on the frame so as to be arranged to form a furrow in the ground as the frame is displaced in the forward working direction;

a container mounted on the frame, the container defining an interior for containing a granular product and a product exit wherefrom the granular product exits the interior of the container;

a pneumatic conveying system including a blower, a plurality of product delivery lines communicating between the blower and said at least one opener, and a product discharge to receive the granular product into the product delivery lines;

the blower being arranged to generate an airflow through the product delivery lines such that the pneumatic conveying system is arranged to carry the granular product from the product discharge to said at least one opener for depositing the granular product into the furrow of said at least one opener;

a metering system in communication between the product exit of the container and the product discharge of the pneumatic conveying system so as to be arranged to transfer metered quantities of the granular product from the product exit to the product discharge; and

a crushing system disposed in series with the metering system between the product exit and the product discharge, the crushing system being arranged for reducing a particle size of the granular product.

Using a crushing system for crushing granular fertilizer, smaller granules of fertilizer can be distributed over a larger area as compared to conventionally used larger granules, so that granular fertilizer can be more evenly spread out over the same area and using the same overall mass of fertilizer as compared to conventionally used larger granules. Such an arrangement provides a more cost effective alternative to liquid applicators which deposit the same kind of product but in liquid form to the agricultural field. The foregoing arrangement may additionally reduce likelihood of fertilizer burn, which occurs when a concentration of the product in the vicinity of a seed exceeds a prescribed acceptable threshold and kills the seed instead of aiding in its germination as originally intended. Furthermore, this arrangement may provide a substantially uniform distribution of the granular product so as to improve an overall germination of the deposited seeds, so as to increase an average concentration of the product in the vicinity of each seed as compared to conventional equipment and techniques for depositing granular products.

In one arrangement, the crushing system is disposed upstream of the metering system relative to a direction of the movement of the granular product from the product exit to the product discharge.

In another arrangement, the crushing system is disposed downstream of the metering system relative to a direction of the movement of the granular product from the product exit to the product discharge.

The crushing system may include a first crushing stage arranged for reducing the granular product from a first size to a second size which is smaller than the first size and a second crushing stage arranged for reducing the granular product from the second size to a third size which is smaller than the second size, the second crushing stage being disposed downstream of the first crushing stage relative to a direction of the movement of the granular product from the product exit to the product discharge.

The first and second crushing stages may be arranged in series.

According to another aspect of the invention there is provided a method of depositing a granular product using an agricultural implement movable in a forward working direction across an agricultural field, comprising:

providing the agricultural implement which includes:
a frame which is arranged for movement in the forward working direction across the agricultural field;
a container mounted on the frame;
the container defining an interior for receiving the granular product and a product exit wherefrom the granular product exits the interior of the container;
a metering system in communication with the product exit so as to receive the granular product from the interior of the container;
the metering system being arranged for metering the granular product in movement from the product exit of the container to a product discharge for eventual delivery to the agricultural field;

storing the granular product in the container;

between the product exit and the product discharge:
metering the granular product so as to form metered quantities of the granular product; and
crushing the granular product so as to form a crushed granular product having reduced size compared to a size of the granular product stored in the container;
breaking a surface of the agricultural field to enable deposition of the granular product into the ground thereof;
and depositing the metered quantities of the crushed granular product into the ground as the agricultural implement is displaced in the forward working direction across the agricultural field.

In one arrangement, crushing the granular product occurs before metering the granular product.

In another arrangement, crushing the granular product occurs after metering the granular product.

Crushing the granular product may include a first crushing step for reducing the granular product from a first size to a second size which is smaller than the first size, and a second crushing step for reducing the granular product from the second size to a third size which is smaller than the second size.

The first and second crushing steps may be performed in series.

### BRIEF DESCRIPTION OF THE DRAWINGS

The invention will now be described in conjunction with the accompanying drawings in which:

FIG. 1 is a schematic diagram of an arrangement of agricultural implement according to the present invention;

FIG. 2A is a schematic representation of distribution of a granular product, such as fertilizer, represented by a square body, relative to a grouping of distinct target bodies, such as seeds, represented by circular bodies, achieved by conventional equipment and techniques;

FIG. 2B is a schematic representation of distribution of the granular product relative to the grouping of target bodies achievable by the arrangement of FIG. 1;

FIGS. 3A and 3B show two possible embodiments of the arrangement of FIG. 1;

FIG. 4 illustrates one embodiment of crushing system usable in the arrangement of agricultural implement of the present invention; and

FIG. 5 schematically shows a two-stage crushing system according to an arrangement of agricultural implement of the present invention.

In the drawings like characters of reference indicate corresponding parts in the different figures.

### DETAILED DESCRIPTION

The accompanying figures show an agricultural implement 10, for example an air drill, for depositing a stored granular product 11 in the ground of an agricultural field 1.

The agricultural implement 10 includes a frame 12 configured for movement typically in a forward working direction 13 across a ground surface 2 of the agricultural field 1. In the illustrated arrangement there is provided at least one wheel 14 rotatably coupled to the frame 12 so that the frame is supported for rolling movement across the ground surface 2, and there is further provided a hitch coupling 15 attached to the frame 12 so that the frame 12 is towable in the forward working direction 13 by a working vehicle 17 such as a tractor.

A container 20 is mounted on the frame 12 for storing the granular product 11 therein. The container 20 defines an interior 22 for receiving the granular product 11 and a product exit 23 wherefrom the granular product 11 exits the interior 22. The product exit 23 typically is disposed near a bottom of the container 20 and a lower portion of the container 20 disposed above the product exit 23 and terminating thereat may be shaped so as to conduce the granular product 11 to move towards the product exit 23 by gravity.

A metering system 26 is in communication with the product exit 23 so as to receive the granular product 11 from the interior 22 of the container 20. The metering system 26 is arranged for metering the granular product 11 in movement generally in direction of series of arrows 27 from the product exit 23 to a product discharge 28, which is in operative communication with a pneumatic conveying system 30 of the agricultural implement 10, for eventual delivery to the agricultural field 1. As such, even though the granular product 11 is stored in bulk in the container 20, the metering system 26 forms metered quantities of the granular product 11 which are smaller in amount than the stored volume of the granular product in the container 20, for controlled or regulated deposition in the field 1. The metering system 26 is of a conventional type which is known to a person of ordinary skill in the art and thus is not described in further detail herein.

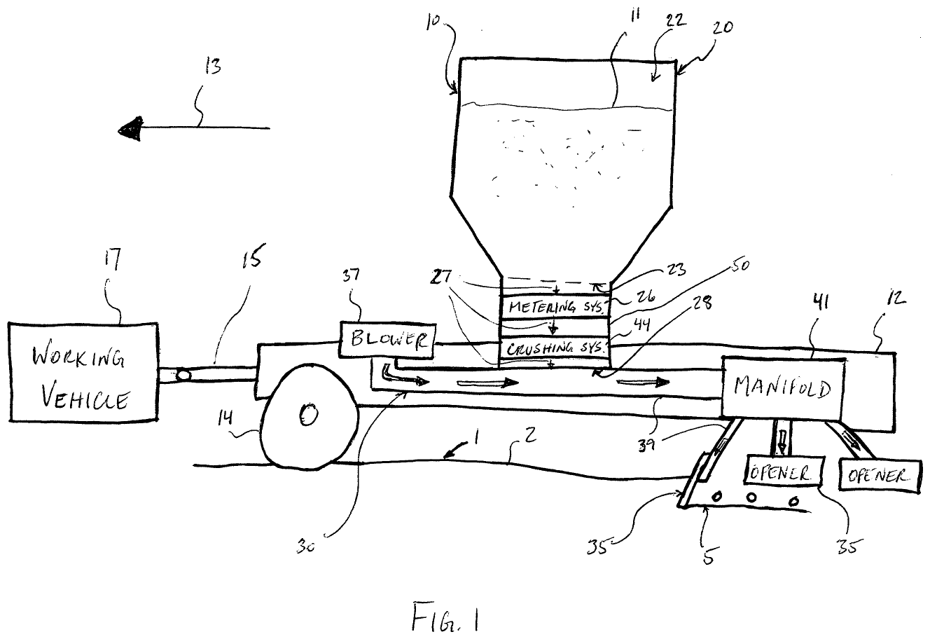

The pneumatic conveying system 30 is arranged for generating an airflow 33 which transfers the granular product 11 received from the product discharge 28 to at least one opener 35. Typically the pneumatic conveying system 30 includes a blower 37 driven to form an air current, which is located upstream from the product discharge 28 relative to a direction of the airflow 33 as depicted in FIG. 1, and a series of pneumatic lines 39 which convey this air current past the product discharge 28, which is communicated with the pneumatic lines 39 and at which the airflow 33 picks up the metered granular product, and to a manifold 41 of the pneumatic conveying system 30 wherefrom the air entrained metered granular product is distributed amongst each one of a plurality of openers 35. The pneumatic conveying system 30 is of a conventional type which is known to a person of ordinary skill in the art and thus is not described in further detail herein.

Each opener 35 is disposed downstream from the product discharge 28 relative to the direction of the airflow 33, that is at a downstream location along the pneumatic conveying system 30, for breaking the ground surface 2 to enable deposition of the metered granular product into the ground of the agricultural field 1. Typically a last or downstream-most one of the series of pneumatic lines 39 which discharges the metered product to the field 1 terminates at a spaced location from a ground engaging tip of the respective opener 35, and rearwardly thereof, so that the metered quantity of product 11 can be deposited into a trench or furrow 5 formed by the opener with a trench bottom below the ground surface 2. The openers 35 may be of a variety of different constructions which are known to a person of ordinary skill in the art and thus the openers are not described in further detail herein.

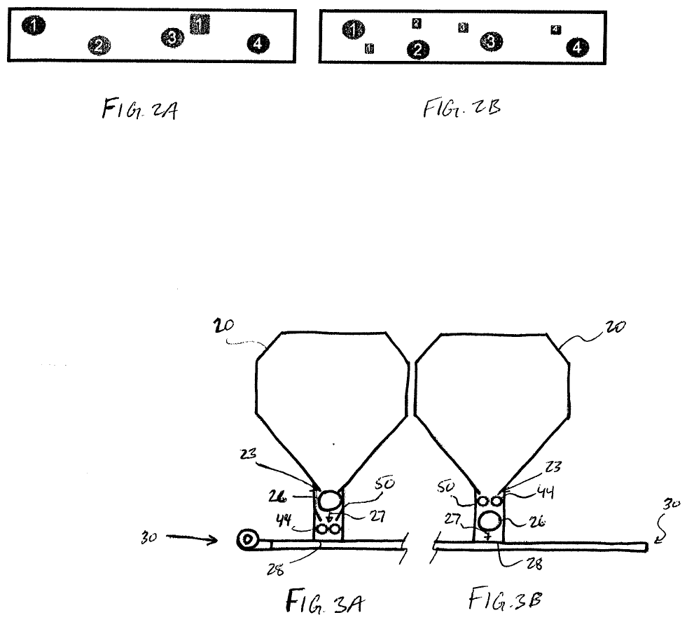

In order to improve distribution of the granular product which is in a solid form over the agricultural field 1, the agricultural implement 10 includes a crushing system 44 arranged for reducing a size of the granular product 11, so as to form a crushed granular product having reduced size compared to a size of the granular product stored in the container 20. The crushing system 44 is disposed in series with the metering system 26 so as to be located between the product exit 23 and the product discharge 28. Thus, instead of resulting in a product distribution like that schematically represented in FIG. 2A, where a single unit of granular product of the standard size in which the product is manufactured and stored in the container is applied to a grouping of distinct target bodies of a prescribed number (for example, in the case of canola, it is recommended that one pellet of granular fertilizer be applied per four seeds of canola), metered quantities of crushed granular product are deposited into the ground as the agricultural implement 10 is displaced in the forward working direction 13 across the agricultural field 1, so as to provide a distribution like that schematically represented in FIG. 2B which is more uniform across all of the target bodies of the grouping such that each target body is exposed to a substantially similar concentration of product. In the illustrated arrangement of FIG. 1 and as shown in FIG. 3A, the crushing system 44 is disposed downstream of the metering system 26 relative to the direction of the movement of the granular product, indicated at 27, from the product exit 23 to the product discharge 28 so as to be located intermediate the metering system 26 and the product discharge 28, such that crushing the granular product occurs after metering the granular product. However, it will be appreciated that in another arrangement like that illustrated in FIG. 3B, the crushing system 44 can be disposed upstream of the metering system 26 relative to the direction of the product movement 27 so as to be located intermediate the product exit 23 and the metering system 26, such that crushing the granular product occurs before metering the granular product.

As shown in FIGS. 3A, 3B and 4 the crushing system 44 may comprise a pair of counter-rotating rollers 47 and 48 mounted within a duct 50 spanning between the product exit 23 and the product discharge 28. The rollers 47, 48 are mounted for rotation about respective spaced rotation axes disposed in a common substantially horizontally oriented plane so as to form a throat between the rollers 47, 48 where the product is crushed. The rollers 47, 48 carry intermeshing protrusions on their cylindrical roller bodies, which act to crush the product 11 passing through the throat. A size of the throat, that is a spacing or clearance between the crusher rolls 47 and 48, is preferably adjustable in size so that the crushing system 44 is adjustable for forming different sizes of crushed product which may be different based on factors such as soil type and moisture levels at the time of product deposition in the field. The rollers 47, 48 may be driven for rotation about their axes by any one of an electric motor, a hydraulic motor, operable connection to a wheel 14 of the implement 10, or a pneumatic arrangement.

The crushing system 44 may be in the form of a removable module which is removably mountable in the duct 50 and supported therein by a plurality of rails supporting the crushing system 44 at walls of the duct 50. The crushing system 44 is preferably made from materials which are corrosion resistant to the product.

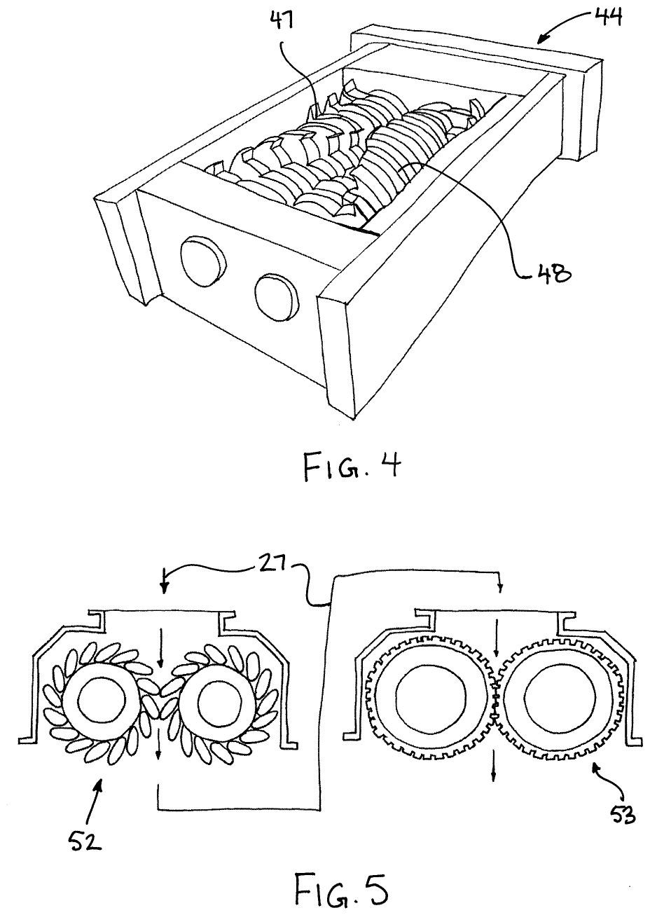

FIG. 5 shows that the crushing system 44 may include a first crushing stage 52 arranged for reducing the granular product 11 from a first size, which is typically the standard size in which the product is manufactured and stored in the container 20, to a second size smaller than the first size, and a second crushing stage 53 arranged for reducing the granular product from the second, already-reduced size to a third size which is smaller than the second size, with the second crushing stage 53 being disposed downstream of the first crushing stage 52 relative to the direction of product movement 27 in the duct 50. Thus, in other words, the crushing system 44 may be arranged such that crushing the granular product includes a first crushing step (performed by the first crushing stage 52) for reducing the granular product from the first size to the smaller second size, and a second crushing step (performed by the second crushing stage 53) for reducing the granular product from the second size to the even smaller third size. The first and second crushing stages 52, 53 may be arranged in series such that the first and second crushing steps are performed in series, in other words consecutively one right after the other, either prior to or after metering.

As described herein, the present invention relates generally to an agricultural implement comprising: (i) a frame configured for movement across a ground surface; (ii) a container mounted on the frame, the container defining an interior for receiving a granular product and a product exit wherefrom the granular product exits the interior of the container; (iii) a metering system in communication with the product exit so as to receive the granular product from the interior of the container, the metering system being arranged for metering the granular product in movement from the product exit of the container to a product discharge which is in operative communication with a pneumatic conveying system of the agricultural implement; (iv) the pneumatic conveying system being arranged for generating an airflow which transfers the granular product received from the product discharge to at least one opener; (v) said at least one opener being disposed downstream from the product discharge relative to a direction of the airflow for breaking the ground surface to enable deposition of the granular product into the ground; and (vi) a crushing system arranged for reducing a size of the granular product and disposed in series with the metering system so as to be located between the product exit and the product discharge.

The scope of the claims should not be limited by the preferred embodiments set forth in the examples but should be given the broadest interpretation consistent with the specification as a whole.

1. An agricultural implement comprising:
a frame configured for movement across ground in a forward working direction;
at least one opener supported on the frame so as to be arranged to form a furrow in the ground as the frame is displaced in the forward working direction;
a container mounted on the frame, the container defining an interior for containing a granular product and a product exit wherefrom the granular product exits the interior of the container;
a pneumatic conveying system including a blower, a plurality of product delivery lines communicating between the blower and said at least one opener, and a product discharge to receive the granular product into the product delivery lines;
the blower being arranged to generate an airflow through the product delivery lines such that the pneumatic conveying system is arranged to carry the granular product from the product discharge to said at least one opener for depositing the granular product into the furrow of said at least one opener;
a metering system in communication between the product exit of the container and the product discharge of the pneumatic conveying system so as to be arranged to transfer metered quantities of the granular product from the product exit to the product discharge; and
a crushing system disposed in series with the metering system between the product exit and the product discharge, the crushing system being arranged for reducing a particle size of the granular product.

2. The agricultural implement of claim 1 wherein the crushing system is disposed between the product exit of the container and the metering system so as to be upstream of the metering system relative to a direction of the movement of the granular product from the product exit to the product discharge.

3. The agricultural implement of claim 1 wherein the crushing system is disposed between the metering system and the product discharge so as to be downstream of the metering system relative to a direction of the movement of the granular product from the product exit to the product discharge.

4. The agricultural implement of claim 1 wherein the crushing system includes a first crushing stage arranged for reducing the granular product from a first size to a second size which is smaller than the first size and a second crushing stage arranged for reducing the granular product from the second size to a third size which is smaller than the second size, the second crushing stage being disposed downstream of the first crushing stage relative to a direction of the movement of the granular product from the product exit to the product discharge.

5. The agricultural implement of claim 4 wherein the first and second crushing stages are arranged in series.

6. A method of depositing a granular product using an agricultural implement movable in a forward working direction across an agricultural field, comprising:
providing the agricultural implement which includes:
a frame which is arranged for movement in the forward working direction across the agricultural field;
a container mounted on the frame;
the container defining an interior for receiving the granular product and a product exit wherefrom the granular product exits the interior of the container;
a metering system in communication with the product exit so as to receive the granular product from the interior of the container;
the metering system being arranged for metering the granular product in movement from the product exit of the container to a product discharge for eventual delivery to the agricultural field;
storing the granular product in the container;
between the product exit and the product discharge:
metering the granular product so as to form metered quantities of the granular product; and
crushing the granular product so as to form a crushed granular product having reduced size compared to a size of the granular product stored in the container;
breaking a surface of the agricultural field to enable deposition of the granular product into the ground thereof;
and depositing the metered quantities of the crushed granular product into the ground as the agricultural implement is displaced in the forward working direction across the agricultural field.

7. The method of claim 6 wherein crushing the granular product occurs before metering the granular product.

8. The method of claim 6 wherein crushing the granular product occurs after metering the granular product.

9. The method of claim 6 wherein crushing the granular product includes a first crushing step for reducing the granular product from a first size to a second size which is smaller than the first size, and a second crushing step for reducing the granular product from the second size to a third size which is smaller than the second size.

10. The method of claim 9 wherein the first and second crushing steps are performed in series.
